(19) United States
(12) Patent Application Publication
(10) Pub. No.: US 2022/0361587 A1
(43) Pub. Date: Nov. 17, 2022

(54) HEATING CONTROL METHOD AND ELECTRONIC VAPORIZATION DEVICE

(71) Applicant: SHENZHEN SMOORE TECHNOLOGY LIMITED, Shenzhen (CN)

(72) Inventors: Jiyong YANG, Shenzhen (CN); Lijun KANG, Shenzhen (CN)

(21) Appl. No.: 17/815,384

(22) Filed: Jul. 27, 2022

Related U.S. Application Data
(63) Continuation of application No. PCT/CN2021/086964, filed on Apr. 13, 2021.

(51) Int. Cl. A24F 40/57; A24F 40/46; G05D 23/19; H05B 1/02; G05B 13/02

(52) U.S. Cl. CPC A24F 40/57; A24F 40/46; G05D 23/1917; H05B 1/0244; G05B 13/0265

(57) ABSTRACT

A heating control method, applicable to a heating element of an electronic vaporization device, includes: controlling the heating element to perform heating to a first preset temperature within a first time period; controlling the heating element to keep working under the first preset temperature within a second time period; and controlling the heating element to decrease from the first preset temperature to a second preset temperature within a third time period. The heating element is controlled to perform heating at at least two different powers within the first time period and/or the second time period.

### CROSS-REFERENCE TO PRIOR APPLICATION

This application is a continuation of International Patent Application No. PCT/CN2021/086964, filed on Apr. 13, 2021. The entire disclosure is hereby incorporated by reference herein.

### FIELD

The present invention relates to the technical field of electronic vaporization devices, and in particular, to a heating control method and an electronic vaporization device.

### BACKGROUND

An electronic vaporization device is a device heats and vaporizes an aerosol-forming substrate to form an aerosol, which is widely applied in fields such as medical care and electronic vaporization.

Currently, the electronic vaporization device has a single heating manner, which generally heats to a preset temperature by using a constant power, and if a preset heating power is relatively high, a heating speed may be fast, and problems such as an extremely high temperature and generation of harmful substances may be caused. If the preset heating power is relatively low, a fragrance reduction degree of vaporization may be not good, and the taste consistency of the aerosol formed through vaporization is relatively poor. Therefore, a heating control method whose heating is fast and safe is required to resolve the problem that the heating speed and the safety cannot be both ensured in the existing technical solutions.

### SUMMARY

In an embodiment, the present invention provides a heating control method, applicable to a heating element of an electronic vaporization device, the method comprising: controlling the heating element to perform heating to a first preset temperature within a first time period; controlling the heating element to keep working under the first preset temperature within a second time period; and controlling the heating element to decrease from the first preset temperature to a second preset temperature within a third time period, wherein the heating element is controlled to perform heating at at least two different powers within the first time period and/or the second time period.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is heating curves of an existing electronic vaporization device at different powers;

FIG. 2 is a curve that a quantity of inhale times changes along with time;

FIG. 3 is a flowchart of a heating control method according to an embodiment of this application;

FIG. 4 is a flowchart of a heating control method according to another embodiment of this application;

FIG. 5 is curves of temperatures change along with a heating time when heating is performed on two ceramics respectively by using a scheme one (A1+B1+C1) according to an embodiment of this application;

FIG. 6 is curves of temperatures change along with time when heating is performed on two ceramics respectively by using a scheme two (A1+B2+C1) according to an embodiment of this application;

FIG. 7 is curves of temperatures change along with time when heating is performed on two ceramics respectively by using a scheme three (A1+B3+C1) according to an embodiment of this application;

FIG. 8 is curves of temperatures change along with time when heating is performed on two ceramics respectively by using a scheme four (A1+B4+C1) according to an embodiment of this application;

FIG. 9 is curves of temperatures change along with a heating time when heating is performed on two ceramics respectively by using a scheme five (A2+B1+C1) according to an embodiment of this application;

FIG. 10 is curves of temperatures change along with a heating time when heating is performed on two ceramics respectively by using a scheme six (A2+B2+C1) according to an embodiment of this application;

FIG. 11 is curves of temperatures change along with a heating time when heating is performed on two ceramics respectively by using a scheme seven (A2+B3+C1) according to an embodiment of this application;

FIG. 12 is curves of temperatures change along with a heating time when heating is performed on two ceramics respectively by using a scheme eight (A2+B5+C1) according to an embodiment of this application;

FIG. 13 is a schematic structural diagram of an electronic vaporization device according to an embodiment of this application; and

FIG. 14 is a schematic structural diagram of an electronic vaporization device according to another embodiment of this application.

### DETAILED DESCRIPTION

In an embodiment, the present invention provides a heating control method and an electronic vaporization device, which can resolve the problem that the heating speed and the safety cannot be both ensured in the existing technical solutions.

In an embodiment, the present invention provides a heating control method. The heating control method is applicable to a heating element of an electronic vaporization device, and the method includes: controlling the heating element to perform heating to a first preset temperature within a first time period; controlling the heating element to keep working under the first preset temperature within a second time period; and controlling the heating element to decrease from the first preset temperature to a second preset temperature within a third time period, where the heating element is controlled to perform heating at at least two different powers within the first time period and/or the second time period.

In an embodiment, the present invention provides an electronic vaporization device. The electronic vaporization device includes a heating element, a power supply component, and a controller, where the heating element is configured to heat an aerosol-forming substrate; the power supply component is connected to the heating element and configured to supply power to the heating element; and the controller is connected between the power supply component and the heating element, and is configured to receive a start instruction of a user and control, according to the start instruction, the power supply component to supply power to the heating element, where the controller controls the heating element to perform heating to a first preset temperature within a first time period; the controller controls the heating element to keep working under the first preset temperature within a second time period; and the controller controls the heating element to decrease from the first preset temperature to a second preset temperature within a third time period, the heating element being controlled to perform heating at at least two different powers within the first time period and/or the second time period.

In an embodiment, the present invention provides an electronic vaporization device. The electronic vaporization device includes at least one processor and a memory communicatively connected to the at least one processor, the memory storing instructions executable by the at least one processor, the instructions, when executed by the at least one processor, causing the at least one processor to perform the heating control method described above.

According to the heating control method and the electronic vaporization device provided in this application, the heating control method is applicable to a heating element of an electronic vaporization device, and a vaporization temperature of an aerosol-forming substrate is reached quickly by controlling the heating element to perform heating to a first preset temperature within a first time period. The heating element is then controlled to keep working under the first preset temperature with a second time period, and the heating element is controlled to perform heating at at least two different powers within the first time period and/or the second time period. Therefore, the vaporization temperature is maintained above a boiling point temperature of the aerosol-forming substrate and below a generation temperature of harmful substances, thereby avoiding occurrence of a problem that harmful substances such as aldehydes and ketones exceed a standard while the vaporization efficiency and a fragrance reduction degree are improved. The heating element is then controlled to decrease from the first preset temperature to a second preset temperature within a third time period, to avoid a problem that a temperature of the heating element generally rises due to the heat accumulation performance of the heating element, thereby effectively ensuring the taste consistency of the aerosol formed through vaporization. Meanwhile, a current vaporization temperature is controlled to be a safe vaporization temperature to keep safe, so that a problem of carbon depositing on a heating surface due to a relatively low vaporization temperature is avoided, and the safety is effectively ensured while fast heating is implemented.

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In this application, the terms “first”, “second”, and “third” are merely intended for a purpose of description, and shall not be understood as an indication or implication of relative importance or implicit indication of the number of indicated technical features. Therefore, features defining “first”, “second”, and “third” can explicitly or implicitly include at least one of the features. In description of this application, “a plurality of” means at least two, such as two and three unless it is specifically defined otherwise. All directional indications (for example, up, down, left, right, front, and back) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

This application is described in detail below with reference to the accompanying drawings and embodiments.

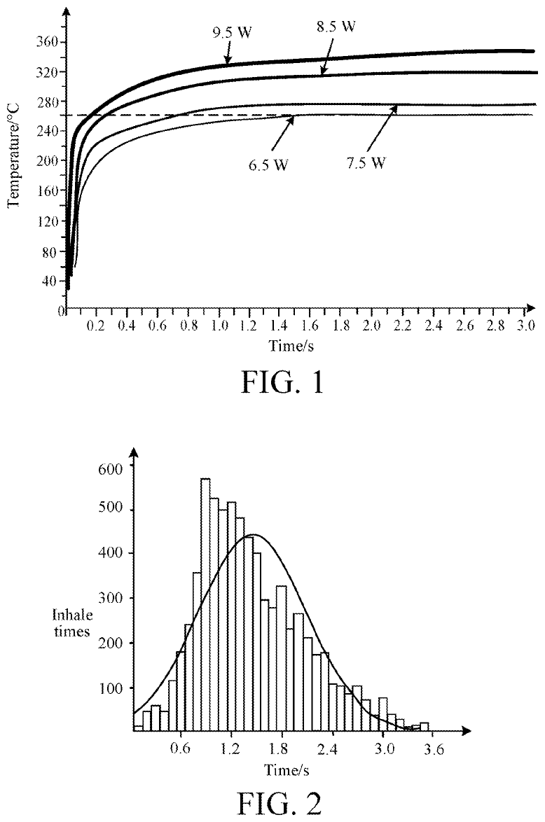

The applicant researches heating curves of an electronic vaporization device at different powers and changes of a quantity of inhale times of a user along with time. As shown in FIG. 1, FIG. 1 is heating curves of an existing electronic vaporization device at different powers. When a heating power is 6.5 W, thermal equilibrium is reached when heating is performed for 1.5 seconds, and a thermal equilibrium temperature is specifically 246° C.; when the heating power is 7.5 W, thermal equilibrium is reached when heating is performed for 0.8 seconds, and the thermal equilibrium temperature is specifically 262° C.; when the heating power is 8.5 W, thermal equilibrium is reached when heating is performed for 0.25 seconds, and the thermal equilibrium temperature is specifically 302° C.; and when the heating power is 9.5 W, thermal equilibrium is reached when heating is performed for 0.1 seconds, and the thermal equilibrium temperature is specifically 340° C. As can be known, when the heating power of the electronic vaporization device 100 is excessively high, problems that an excessively high temperature and harmful substances such as heavy metals and aldehydes and ketones exceed a standard may be caused; and when the heating power is excessively low, a problem that a fragrance reduction degree of vaporization is not good may be caused. As shown in FIG. 2, FIG. 2 is a curve that a quantity of inhale times changes along with time. A specific quantity of sampled persons is 40, and a specific quantity of inhale times of each person is 200. As can be known from FIG. 2, although inhale habits of each user varies, an inhale time of each user is concentrated around 0.6 seconds to 2.5 seconds. Meanwhile, since the inhale habits of each user varies, if heating is performed continuously or repeatedly by using the same mode, changes of a gradually increased temperature of the heating element 101 vary greatly, leading to relatively poor taste consistency of the aerosol formed through vaporization.

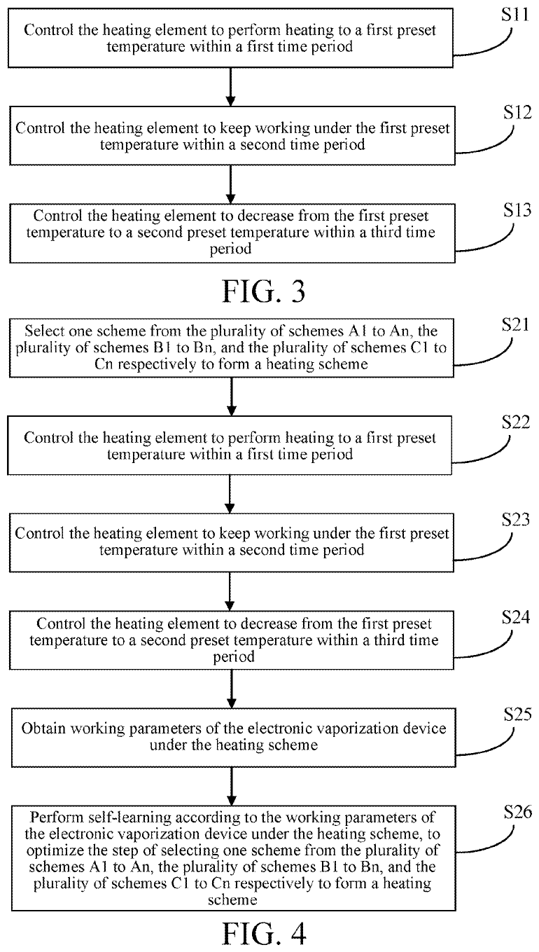

Referring to FIG. 3, FIG. 3 is a flowchart of a heating control method according to an embodiment of this application. In this embodiment, a heating control method is provided, and the heating control method may be applicable to heating element 101 of the electronic vaporization device 100. The electronic vaporization device 100 is configured to heat and vaporize an aerosol-forming substrate to generate an aerosol, the aerosol-forming substrate is liquid or solid including components such as flavor materials or effective materials, and the effective materials may be nicotine or nicotine salt. Specifically, the electronic vaporization device 100 includes a vaporizer and a main unit. The vaporizer is detachably connected to the main unit. The vaporizer is configured to heat and vaporize the aerosol-forming substrate when powered on. A power supply component is disposed in the main unit, and the vaporizer is inserted into an interface of one end of the main unit and connected to the power supply component in the main unit, so that power is supplied to the vaporizer through the power supply component. When the vaporizer needs to be replaced, the vaporizer may be detached and a new vaporizer is mounted on the main unit to reuse the main unit. Certainly, the electronic vaporization device 100 further includes other components in the existing electronic vaporization device such as a microphone and a holder, and specific structures and functions of these components are the same as or similar to those in the related art, for details, reference may be made to the related art, and details are not described herein again.

Specifically, the heating control method includes:

Step S11: Control the heating element to perform heating to a first preset temperature within a first time period.

Specifically, within the first time period, heating may be performed at a constant power or may be performed at at least two different powers.

In an embodiment, within the first time period, heating is performed at at least two different powers to control the heating element 101 to rise from an environment temperature to the first preset temperature. The first time period does not exceed 0.5 seconds, so as to reduce a preheating time, accelerate heating, and improve the vaporization efficiency. Specifically, the first preset temperature is not less than a boiling point temperature of the current aerosol-forming substrate and is less than a generation temperature of harmful substances. For example, a liquid aerosol-forming substrate generally includes vegetable glycerine (VG), propylene glycol (PG), and fragrances in different flavors, where a boiling point of the PG is around 185° C., and a boiling point of the VG is around 290° C. Although a higher temperature is beneficial to improving a vaporization amount, when the temperature is excessively high, the aerosol-forming substrate may be resolved into harmful substances such as aldehydes and ketones. Therefore, enabling the current heating temperature to reach a vaporization temperature of the aerosol-forming substrate quickly is taken into comprehensive consideration, which helps vaporize the aerosol-forming substrate and avoid problems that harmful substances such as aldehydes and ketones exceed a standard. Specifically, a setting range of the first preset temperature may be from 220° C. to 320° C. Preferably, the setting range of the first preset temperature may be from 250° C. to 300° C. It may be understood that, the first preset temperature may be any one of 250° C., 280° C., or 300° C. in the foregoing range. Meanwhile, according to an actual temperature control precision requirement, the first preset temperature may alternatively be a range fluctuating within a preset range amplitude. For example, the first preset temperature is 280° C., but an actual temperature ranges from 270° C. to 290° C.

In an embodiment, heating may be performed sequentially in descending order of the at least two different powers; and a range of each power may be from 8 W to 11 W. In addition, heating times of the at least two different powers may be the same or different. It may be understood that, performing heating sequentially in descending order of powers may obtain a smooth heating curve, so that a temperature of the first time period of the heating stage may be transitioned to the first preset temperature smoothly, to prevent the temperature of the heating stage from being higher than the first preset temperature.

In a specific implementation process, heating may be performed by using three different powers and heating times thereof are the same. In this embodiment, step S11 specifically may adopt any scheme in the following two schemes: Scheme one A1: within the first time period, the heating element 101 is controlled to perform heating at 11 W for 0.1 seconds, then perform heating at 9 W for 0.1 seconds, and perform heating at 8 W for 0.1 seconds to rise from an environment temperature to the first preset temperature. In this implementation scheme, the range of the first preset temperature may be from 310° C. to 320° C. Scheme two A2: within the first time period, the heating element 101 is controlled to perform heating at 10 W for 0.1 seconds, then perform heating at 9 W for 0.1 seconds, and perform heating at 8 W for 0.1 seconds to rise from an environment temperature to the first preset temperature. In this implementation scheme, the range of the first preset temperature may be from 290° C. to 300° C. Certainly, in other embodiments, the first time period is relatively short, so that heating may be performed continuously within the time period at a constant heating power. For example, in a scheme three or a scheme four, the heating element 101 is controlled to rise from the environment temperature to the first preset temperature within the first time period. The scheme three A3 is: within the first time period, the heating element 101 is controlled to perform heating at 10 W for 0.2 seconds to rise from the environment temperature to the first preset temperature; and the scheme four A4 is: within the first time period, the heating element 101 is controlled to perform heating at 10 W for 0.4 seconds to rise from the environment temperature to the first preset temperature.

Step S12: Control the heating element to keep working under the first preset temperature within a second time period. Specifically, a minimum heating power within the first time period is not less than a maximum heating power within the second time period, to ensure that heating may be performed quickly within the first time period, and problems such as an excessively high temperature and generation of harmful substances due to an excessively high heating power may not occur within the second time period. Specifically, heating may be also performed at a constant power or at least two different powers within the second time period. However, the heating element 101 is controlled to perform heating at at least two different powers within at least one time period of the first time period and the second time period.

In an embodiment, if heating is performed at at least two different powers within the first time period, for example, step S11 is performed by using the scheme one A1 or the scheme two A2, step S12 may perform heating at a constant heating power to keep working under the first preset temperature. For example, heating is performed by using a scheme one B1 or a scheme two B2 within the second time period. The scheme one B1 is: the heating element 101 is controlled to perform heating at 6.5 W for 2.7 seconds within the second time period to keep working under the first preset temperature; and the scheme two B2 is: the heating element 101 is controlled to perform heating at 7 W for 2.7 seconds within the second time period to keep working under the first preset temperature.

Certainly, heating may be also performed at at least two different powers within the second time period to control the heating element 101 to keep working under the first preset temperature. It should be noted that, in this case, heating may be alternatively performed at a constant power within the first time period. A time range of the second time period may be from 2 seconds to 3 seconds. The first preset temperature is not less than the boiling point temperature of the aerosol-forming substrate and is less than the generation temperature of the harmful substances such as aldehydes and ketones, so that not only the vaporization efficiency of the electronic vaporization device 100 can be ensured, the problem that the harmful substances exceed a standard may be also prevented.

When heating is performed at at least two different powers within the second time period, step S12 may specifically adopt at least two different powers to perform heating circularly and alternately, and heating times of the at least two different powers may be the same or different. A range of each power in the at least two different powers in step S12 may be from 6 W to 7.5 W.

In a specific embodiment, the heating times of the at least two different powers are the same, and an example in which the two powers for circularly and alternately performed heating are 6.5 W and 7 W respectively, and the heating times are 0.1 seconds, 0.2 seconds, or 0.3 seconds is used. Step S12 may be specifically performed through any one scheme of the following three schemes. Scheme three B3: the heating element 101 is controlled to perform heating at 6.5 W for 0.1 seconds, perform heating at 7 W for 0.1 seconds, perform heating at 6.5 W for 0.1 seconds, and perform heating at 7 W for 0.1 seconds, and this process is performed alternately and circularly to a preset duration; scheme four B4: the heating element 101 is controlled to perform heating at 6.5 W for 0.2 seconds, perform heating at 7 W for 0.2 seconds, perform heating at 6.5 W for 0.2 seconds, and perform heating at 7 W for 0.2 seconds, and this process is performed alternately and circularly to a preset duration; and scheme five B5: the heating element 101 is controlled to perform heating at 6.5 W for 0.3 seconds, perform heating at 7 W for 0.3 seconds, perform heating at 6.5 W for 0.3 seconds, and perform heating at 7 W for 0.3 seconds, and this process is performed alternately and circularly to a preset duration, where the preset duration is a duration of the second time period, and the preset duration may be a standard inhale duration of a single inhale of the user, which specifically may be 3 seconds. It may be understood that, performing heating circularly and alternately at at least two different powers can better control the heating temperature to be less than the first preset temperature, thereby avoiding generation of harmful substances due to an excessively high temperature and also ensuring relatively high vaporization efficiency.

In another specific embodiment, the heating times of the at least two different powers are different, and an example in which the two powers for circularly and alternately performed heating are 6.5 W and 7 W respectively, and the heating times are 1.2 seconds or 0.3 seconds is used. Step S12 may be specifically performed through any one scheme of the following two schemes. scheme six B6: the heating element 101 is controlled to perform heating at 6.5 W for 1.2 seconds, perform heating at 7 W for 0.3 seconds, perform heating at 6.5 W for 1.2 seconds, and perform heating at 7 W for 0.3 seconds, and this process is performed alternately and circularly to a preset duration; and scheme seven B7: the heating element 101 is controlled to perform heating at 7 W for 1.2 seconds, perform heating at 6.5 W for 1.2 seconds, perform heating at 7 W for 1.2 seconds, and perform heating at 6.5 W for 1.2 seconds, and this process is performed alternately and circularly to a preset duration.

In a specific embodiment, preferably, the scheme two A2 and the scheme six B6 may be adopted, which can not only improve the vaporization efficiency and a fragrance reduction degree, but also can avoid the problems that the temperature of the heating element 101 is excessively high and the harmful substances exceed a standard.

Step S13: Control the heating element to decrease from the first preset temperature to a second preset temperature within a third time period.

The second preset temperature is lower than the first preset temperature, to avoid a problem that the temperature of the heating element 101 gradually increases due to the heat accumulation performance of the heating element 101, thereby effectively ensuring the taste consistency of the aerosol formed through vaporization. Meanwhile, a current vaporization temperature is controlled to be a safe vaporization temperature to keep safe, so that a problem of carbon depositing on a heating surface due to a relatively low vaporization temperature is avoided. In addition, it is also ensured that the first preset temperature can be quickly reached during next inhaling. A setting range of the second preset temperature may be from 220° C. to 280° C.

Specifically, the heating element 101 may be controlled to perform heating at a constant power within the third time period; and a power range of the constant heating power specifically may be from 4.5 W to 5.5 W. Preferably, the constant power may be 4.5 W. A duration range of the third time period may be from 2.5 seconds to 3 seconds, and preferably, may be 2 seconds. Specifically, Step S13 may be performed by adopting a scheme one C1 or a scheme two C2, where the scheme one C1 is to perform heating at 4.5 W for 2 seconds; and the scheme two C2 is to perform heating at 5 W for 2 seconds.

Specifically, a time that the heating element 101 decreases from the first preset temperature to the second preset temperature does not exceed 0.6 seconds, to avoid the problem that the harmful substances such as aldehydes and ketones or heavy metals exceed a standard caused by the continuously increased temperature.

In a specific embodiment, the first time period, the second time period, and the third time period are time periods that are consecutive in time, so that the heating element 101 keeps working for vaporization to form an aerosol.

According to the heating control method provided in this embodiment, the heating element 101 is controlled to perform heating to the first preset temperature within the first time period, so that the vaporization temperature of the aerosol-forming substrate is quickly reached. The heating element 101 is then controlled to keep working under the first preset temperature with the second time period, and the heating element 101 is controlled to perform heating at at least two different powers within the first time period and/or the second time period. Therefore, the vaporization temperature is maintained above the boiling point of the aerosol-forming substrate and below the generation temperature of the harmful substances such as aldehydes and ketones or heavy metals, thereby avoiding occurrence of the problem that the harmful substances such as aldehydes and ketones exceed a standard while the vaporization efficiency and a fragrance reduction degree are improved. The heating element 101 is then controlled to decrease from the first preset temperature to the second preset temperature within the third time period and keep working under the second preset temperature to the preset duration, to avoid the problem that the temperature of the heating element 101 generally increases due to the heat accumulation performance of the heating element 101, thereby effectively ensuring the taste consistency of the aerosol formed through vaporization. Meanwhile, a current vaporization temperature is controlled to be a safe vaporization temperature to keep safe, so that the problem of carbon depositing on a heating surface due to a relatively low vaporization temperature is avoided. Further, the safety can be effectively ensured while quick heating is implemented.

In another embodiment, referring to FIG. 4, FIG. 4 is a flowchart of a heating control method according to another embodiment of this application. In this embodiment, another heating control method is provided. Specifically, the electronic vaporization device 100 stores a plurality of schemes A1 to An controlling the heating element 101 to perform heating at at least two different powers or a constant power within the first time period, a plurality of schemes B1 to Bn controlling the heating element 101 to perform heating at at least two different powers or a constant power within the second time period, and a plurality of schemes C1 to Cn controlling the heating element 101 to perform heating at a constant power within the third time period, where the plurality of schemes A1 to An may include any one or more of the A1, A2, A3, and A4 involved in the foregoing embodiment; the plurality of schemes B1 to Bn may include any one or more of the B1, B2, B3, B4, B5, B6, and B7 involved in the foregoing embodiment; and the plurality of schemes C1 to Cn may include any one or more of the C1 and C2 involved in the foregoing embodiment. It may be understood that, n is a natural number; and n may be specifically set according to hardware indicators such as an internal memory. Specifically, the heating control method specifically includes: step S21: selecting one scheme from the plurality of schemes A1 to An, the plurality of schemes B1 to Bn, and the plurality of schemes C1 to Cn respectively to form a heating scheme.

In a specific implementation process, parameters of the electronic vaporization device 100 or inhale habit parameters of a user are obtained, where the parameters of the electronic vaporization device 100 include parameters of a vaporization substrate or parameters of a vaporizer; and one scheme is then selected from the plurality of schemes A1 to An, the plurality of schemes B1 to Bn, and the plurality of schemes C1 to Cn respectively according to the parameters of the electronic vaporization device 100 or the inhale habit parameters of the user to form a heating scheme, and at least one scheme of the schemes selected from the plurality of schemes A1 to An and the plurality of schemes B1 to Bn is to perform heating at different powers. The inhale habit parameters of the user include a single inhale duration of the user. Specifically, it is detected that an inhale habit of the user is that the single inhale duration is 3 seconds. It may be understood that, in this case, a total heating duration of the heating scheme formed by selecting one scheme from the plurality of schemes A1 to An, the plurality of schemes B1 to Bn, and the plurality of schemes C1 to Cn respectively is 3 seconds. In other implementations, the total heating duration may be another inhale duration of the user, such as 2.5 seconds, 4 seconds, or 5 seconds.

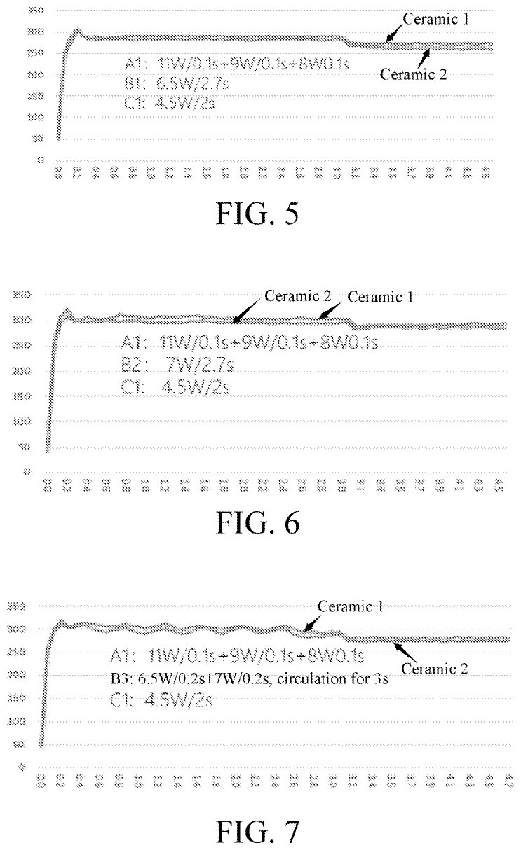

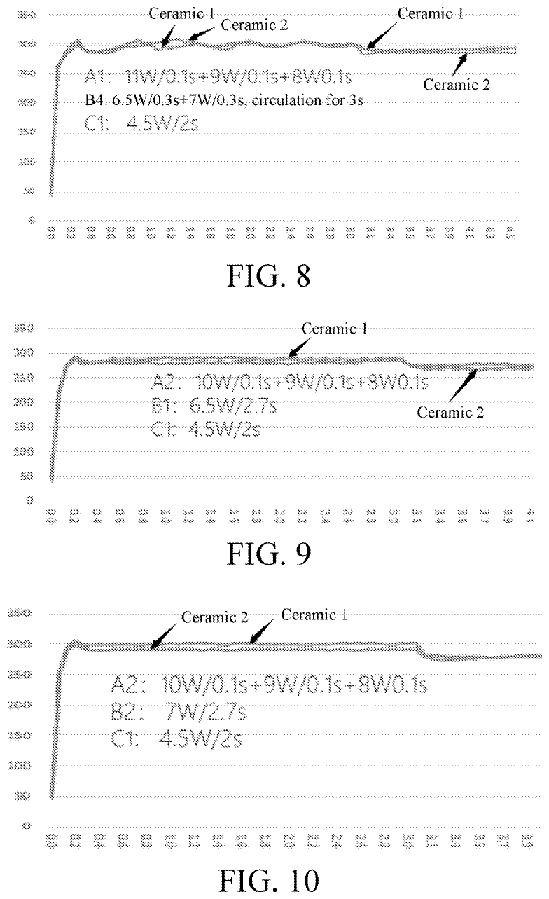

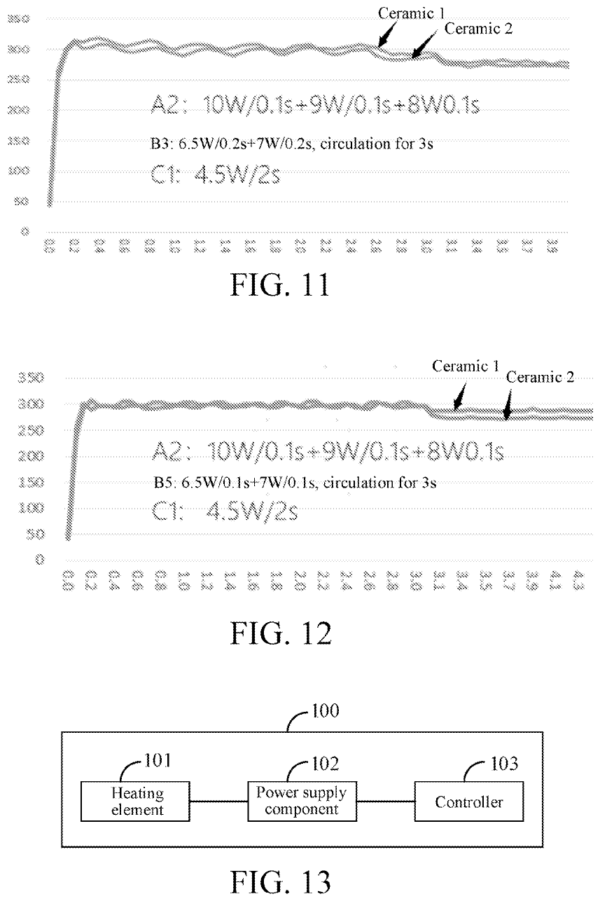

In a specific embodiment, four different schemes of A1/A2+B1/B2+C1 and four different schemes A1/A2+B3/B4/B5+C1 are selected to research changes of temperatures of two ceramics along with a heating time. For details, reference may be made to FIG. 5 to FIG. 12 and Table 1, where FIG. 5 is curves of temperatures change along with a heating time when heating is performed on two ceramics respectively by using a scheme one (A1+B1+C1) according to an embodiment of this application; FIG. 6 is curves of temperatures change along with time when heating is performed on two ceramics respectively by using a scheme two (A1+B2+C1) according to an embodiment of this application; FIG. 7 is curves of temperatures change along with time when heating is performed on two ceramics respectively by using a scheme three (A1+B3+C1) according to an embodiment of this application; FIG. 8 is curves of temperatures change along with time when heating is performed on two ceramics respectively by using a scheme four (A1+B4+C1) according to an embodiment of this application; FIG. 9 is curves of temperatures change along with a heating time when heating is performed on two ceramics respectively by using a scheme five (A2+B1+C1) according to an embodiment of this application; FIG. 10 is curves of temperatures change along with a heating time when heating is performed on two ceramics respectively by using a scheme six (A2+B2+C1) according to an embodiment of this application; FIG. 11 is curves of temperatures change along with a heating time when heating is performed on two ceramics respectively by using a scheme seven (A2+B3+C1) according to an embodiment of this application; and FIG. 12 is curves of temperatures change along with a heating time when heating is performed on two ceramics respectively by using a scheme eight (A2+B5+C1) according to an embodiment of this application.

As can be known from FIG. 5 to FIG. 12, an average temperature of the scheme one B1 is lower than an average temperature of the scheme two B2 by 8° C. to 16° C., and a maximum temperature of A1 is higher than a maximum temperature of A2 by 5° C. to 15° C.

Table 1 shows performance parameters corresponding to the eight different schemes.

| | | Maximum | | Average | Total power |
|---|---|---|---|---|---|
| | | temperature | Duration | temperature | consumption of |
| | | within the first | corresponding | within the second | a single inhale |
| Serial number | Scheme | time period | to the first time | time period | duration |
| of schemes | combination | (° C.) | period (s) | (° C.) | (mW) |
| Scheme one | A1 + B1 + C1 | 312 | 0.2 | 289 | 20.3 |
| Scheme two | A1 + B2 + C1 | 316 | 0.2 | 305 | 21.7 |
| Scheme three | A1 + B3 + C1 | 318 | 0.2 | 304 | 20.95 |
| Scheme four | A1 + B4 + C1 | 305 | 0.2 | 293 | 20.9 |
| Scheme five | A2 + B1 + C1 | 296 | 0.2 | 287 | 20.2 |
| Scheme six | A2 + B2 + C1 | 306 | 0.2 | 300 | 21.6 |
| Scheme seven | A2 + B3 + C1 | 309 | 0.2 | 304 | 20.85 |
| Scheme eight | A2 + B5 + C1 | 302 | 0.2 | 291 | 20.8 |

The single inhale duration is specifically 3 seconds. As can be known from Table 1, the maximum temperature in stage A2 is below 310° C., which is relatively safe, and heating times are all 0.2 seconds, which meets a quick heating requirement. Therefore, in a specific implementation process, the scheme two A2 is specifically adopted within the first time period. In addition, constant temperature stages of the scheme five and the scheme six adopt a constant power, and the scheme seven and the scheme eight adopt a pulse power. In a specific implementation process, two modes respectively select two schemes to test two samples and both use mung bean e-liquid, and for detection results, reference may be made to Table 2 and Table 3. A power corresponding to a control group may be 6.5 W.

Table 2 shows test results obtained by testing two different samples by using the scheme five to the scheme eight with different powers in combination with the control group.

| | Control group | | | | | | | | | |
|---|---|---|---|---|---|---|---|---|---|---|
| | 6.5 W | | Scheme five | | Scheme six | | Scheme seven | | Scheme eight | |
| | Sample | Sample | Sample | Sample | Sample | Sample | Sample | Sample | Sample | Sample |
| | 1 | 2 | 1 | 2 | 1 | 2 | 1 | 2 | 1 | 2 |
| Inhaling | 0.92 | 0.73 | 0.71 | 0.80 | 0.81 | 0.73 | 0.79 | 0.76 | 0.78 | 0.74 |
| force | | | | | | | | | | |
| (Kpa) | | | | | | | | | | |
| Inhale | ΔM/mg | ΔM/mg | ΔM/mg | ΔM/mg | ΔM/mg | ΔM/mg | ΔM/mg | ΔM/mg | ΔM/mg | ΔM/mg |
| times | | | | | | | | | | |
| 25 | 7.16 | 6.72 | 7.40 | 7.13 | 8.86 | 8.34 | 8.14 | 8.20 | 8.46 | 8.14 |
| 50 | 7.42 | 6.71 | 7.43 | 7.66 | 8.52 | 8.00 | 8.27 | 8.46 | 7.96 | 8.42 |
| 75 | 7.21 | 6.86 | 7.72 | 7.32 | 8.41 | 8.41 | 8.44 | 8.12 | 8.16 | 8.16 |
| 100 | 7.10 | 6.91 | 7.93 | 6.93 | 8.70 | 7.90 | 7.97 | 8.07 | 8.61 | 8.07 |
| 125 | 7.18 | 6.71 | 7.62 | 7.29 | 8.26 | 8.66 | 8.42 | 8.16 | 8.46 | 8.12 |
| 150 | 7.31 | 6.77 | 7.85 | 6.94 | 8.84 | 8.44 | 8.14 | 8.38 | 8.14 | 8.04 |
| 175 | 7.26 | 6.36 | 8.03 | 7.82 | 8.58 | 8.54 | 8.01 | 8.45 | 8.22 | 8.43 |
| Minimum | 7.10 | 6.36 | 7.40 | 6.93 | 8.26 | 7.90 | 7.97 | 8.07 | 7.96 | 8.04 |
| value | | | | | | | | | | |
| Maximum | 7.42 | 6.91 | 8.03 | 7.82 | 8.86 | 8.66 | 8.44 | 8.46 | 8.61 | 8.43 |
| value | | | | | | | | | | |
| Average | 7.23 | 6.72 | 7.71 | 7.30 | 8.60 | 8.33 | 8.20 | 8.26 | 8.29 | 8.19 |
| vapor | | | | | | | | | | |
| amount | | | | | | | | | | |
| (mg/puff) | | | | | | | | | | |

Table 3 shows vaporization efficiency corresponding to the scheme five to the scheme eight with different powers and the control group.

| | | Total power | |
|---|---|---|---|
| | | consumption | |
| | Vaporization | of a single | |
| | amount | inhale duration | Vaporization |
| | (mg/puff) | (mW) | efficiency |
| Constant power 6.5 W | 6.97 | 19.5 | 49% |
| Scheme five with | 7.52 | 20.2 | 53% |
| different powers | | | |
| Scheme six with | 8.47 | 21.6 | 55% |
| different powers | | | |
| Scheme seven with | 8.23 | 20.85 | 54% |
| different powers | | | |
| Scheme eight with | 8.24 | 20.8 | 54% |
| different powers | | | |

As can be known from Table 3, the vaporization efficiency of the scheme of performing heating at at least two different powers provided in this application is improved by 4% to 6% when compared with the scheme of performing heating at a constant power 6.5 W in the control group.

Table 4 shows taste results corresponding to the scheme five to the scheme eight with different powers and the control group.

| | Sample 1 | Sample 2 | Sample 3 | Sample 4 |
|---|---|---|---|---|
| Control group | Sense of | Relatively weak | Intermediate | Intermediate |
| (6.5 W) | satisfaction | | | |
| | Fragrance | Intermediate | Intermediate | Intermediate |
| | concentration | | | |
| | Fragrance | Intermediate | Intermediate | Relatively good |
| | reduction degree | | | |
| | Throat striking | Relatively weak | Intermediate | Relatively strong |
| | sense | | | |
| Scheme five | Sense of | Relatively weak | Intermediate | Intermediate |
| | satisfaction | | | |
| | Fragrance | Intermediate | Intermediate | Relatively good |
| | concentration | | | |
| | Fragrance | Relatively good | Relatively good | Relatively good |
| | reduction degree | | | |
| | Throat striking | Relatively weak | Intermediate | Relatively strong |
| | sense | | | |
| Scheme six | Sense of | Relatively weak | Intermediate to | Intermediate |
| | satisfaction | | relatively strong | |
| | Fragrance | Intermediate | Intermediate | Intermediate |
| | concentration | | | |
| | Fragrance | Relatively good | Relatively good | Intermediate |
| | reduction degree | | | |
| | Throat striking | Relatively good | Intermediate to | Relatively strong |
| | sense | | relatively strong | |
| Scheme seven | Sense of | Intermediate | Intermediate to | Intermediate to |
| | satisfaction | | relatively strong | relatively strong |
| | Fragrance | Intermediate | Intermediate to | Relatively good |
| | concentration | | relatively good | |
| | Fragrance | Relatively good | Relatively good | Intermediate |
| | reduction degree | | | |
| | Throat striking | Relatively weak | Intermediate to | Relatively strong |
| | sense | | relatively strong | |
| Scheme eight | Sense of | Relatively weak | Intermediate to | Intermediate |
| | satisfaction | | relatively strong | |
| | Fragrance | Intermediate | Intermediate to | Relatively good |
| | concentration | | relatively good | |
| | Fragrance | Relatively good | Relatively good | Intermediate |
| | reduction degree | | | |
| | Throat striking | Relatively weak | Intermediate to | Relatively strong |
| | sense | | relatively strong | |

As can be known from Table 4, compared with the constant power 6.5 W, the scheme of using at least two different powers has improvements on aspects such as the vapor amount, the fragrance reduction degree, and the fragrance concentration. In addition, on the whole, performance of indicators of the scheme seven is the best. Therefore, in a specific implementation process, the scheme seven may be selected to perform heating control.

Table 5 shows test results of e-liquid frying sound under different inhale times corresponding to the scheme five to the scheme eight with different powers and the control group.

| | Control | | | | |
|---|---|---|---|---|---|
| | group | Scheme | Scheme | Scheme | Scheme |
| | 6.5 W | five | six | seven | eight |
| First | Relatively | Relatively | Relatively | Relatively | Relatively |
| inhale | small | great | great | great | great |
| Second | Relatively | Relatively | Relatively | Relatively | Relatively |
| inhale | great | great | great | great | great |
| Third | Relatively | Relatively | Relatively | Relatively | Relatively |
| inhale | small | great | great | great | great |
| Fourth | Relatively | Relatively | Relatively | Relatively | Relatively |
| inhale | small | great | great | great | small |
| Fifth | None | Relatively | Relatively | Relatively | Relatively |
| inhale | | great | great | great | great |
| Sixth | Relatively | Relatively | Relatively | Relatively | Relatively |
| inhale | small | great | great | small | small |
| Seventh | None | Relatively | Relatively | Relatively | Relatively |
| inhale | | small | great | great | great |
| Eighth | Relatively | Relatively | Relatively | Relatively | Relatively |
| inhale | great | great | great | small | small |
| Ninth | Relatively | Relatively | Relatively | None | Relatively |
| inhale | small | great | great | | great |
| Tenth | Relatively | Relatively | Relatively | Relatively | Relatively |
| inhale | small | great | great | great | great |

It should be noted that, in a specific test process, after one time of inhale, a preset time is waited, and the second inhale is performed after a cartridge is completely cooled down. The preset time may be 3 minutes, 5 minutes, or 6 minutes. As can be known from Table 5, compared with the scheme of performing heating at a constant power 6.5 W, the e-liquid frying sound of a cotton-core cartridge is more apparent in a process of implementing quick heating according to the scheme of performing heating at at least two different powers. In addition, a difference between the e-liquid frying sound of the four schemes of the scheme five the scheme eight of performing heating at at least two different powers is relatively small.

Step S22: Control the heating element to perform heating to a first preset temperature within a first time period.

Step S23: Control the heating element to keep working under the first preset temperature within a second time period. Step S24: Control the heating element to decrease from the first preset temperature to a second preset temperature within a third time period.

Specifically, step S22 to step S24 are performed according to the heating scheme in step S21, and a specific implementation process is the same as or similar to the specific implementation process of step S1l to step S13 provided in the first embodiment, and the same or similar technical effects may be also implemented. For details, reference may be made to the foregoing related text description, and details are not described herein again.

Step S25: Obtain working parameters of the electronic vaporization device under the heating scheme.

The parameters of the electronic vaporization device 100 include parameters of a vaporization substrate or parameters of a vaporizer; and the vaporization substrate may be liquid or solid including components such as flavor materials or effective materials, and the effective materials may be nicotine or nicotine salt; and the parameters of the vaporizer may include a current heating power, a heating time, or a heating temperature.

Step S26: Perform self-learning according to the working parameters of the electronic vaporization device under the heating scheme, to optimize the step of selecting one scheme from the plurality of schemes A1 to An, the plurality of schemes B1 to Bn, and the plurality of schemes C1 to Cn respectively to form a heating scheme.

As can be known in combination with the foregoing data, according to the heating control method provided in the embodiments of this application, the vaporization efficiency may be improved by 4% to 6%, the fragrance reduction degree is also improved apparently, and e-liquid frying frequency of a universal cotton-core product is increased and the sound thereof is more apparent.

According to the heating control method provided in this embodiment, a plurality of different schemes are pre-stored in the electronic vaporization device 100, so that in a specific heating process, a heating scheme may be formed by combining different schemes through matching between different vaporization substrates and the vaporizer. Therefore, heating control is performed within different time periods based on the selected scheme, so that the problems that the heating element is excessively high, the harmful substances exceed a standard, and carbon depositing on a heating surface due to a relatively low vaporization temperature may be avoided while ensuring the vaporization efficiency, and the safety can be effectively ensured while quick heating is implemented. Meanwhile, the taste consistency of the aerosol formed through vaporization may be effectively ensured.

Referring to FIG. 13, FIG. 13 is a schematic structural diagram of an electronic vaporization device according to an embodiment of this application. In this embodiment, an electronic vaporization device 100 is provided, and the electronic vaporization device 100 specifically includes a heating element 101, a power supply component 10, and a controller 103.

In an embodiment, the heating element 101 is disposed on a porous ceramic in the vaporizer, and the power supply component 102 and the controller 103 are disposed on a battery holder of a main unit. The vaporizer and the main unit may be an integral structure or may be detachably connected.

The heating element 101 is configured to heat an aerosol-forming substrate; and the aerosol-forming substrate may be tobacco or e-liquid. The heating element 101 specifically may be made of a temperature control heating material, and certainly may alternatively be made of a non-temperature control heating material. The temperature control heating material is a material with a relatively large temperature coefficient of resistance(TCR) value, and the non-temperature control heating material is a material with a relatively small TCR value.

The power supply component 102 is connected to the heating element 101 and is configured to supply power to the heating element 101.

In a specific embodiment, the power supply component 102 may be disposed in the main unit of the electronic vaporization device 100 and may be specifically a rechargeable battery or battery pack. The controller 103 may be a chip or a printed circuit board. The controller 103 is connected between the power supply component 102 and the heating element 101, and is configured to receive a start instruction of a user and control, according to the start instruction, the power supply component 102 to supply power to the heating element 101.

In a specific embodiment, the controller 103 controls the heating element 101 to perform heating from an environment temperature to a first preset temperature within a first time period; the controller 103 controls the heating element 101 to keep working under the first preset temperature within a second time period; and the controller 103 controls the heating element 101 to decrease from the first preset temperature to a second preset temperature within a third time period and keep working under the second preset temperature to a preset duration. The heating element 101 is controlled to perform heating at at least two different powers within the first time period and/or the second time period.

According to the electronic vaporization device 100 provided in this embodiment, the heating element 101 is disposed to heat an aerosol-forming substrate. Meanwhile, the power supply component 102 connected to the heating element 101 is disposed to supply power to the heating element 101 through the power supply component 102. In addition, the controller 103 connected to the power supply component 102 and the heating element 101 is disposed, so that the heating element 101 is controlled by the controller 103 to rise from the environment temperature to the first preset temperature within the first time period, to quickly reach a vaporization temperature of the aerosol-forming substrate. The heating element 101 is controlled to keep working under the first preset temperature within the second time period, and the heating element 101 is controlled to perform heating at different powers within the first time period and/or the second time period, to maintain the vaporization temperature to be above a boiling point of the aerosol-forming substrate and below a generation temperature of harmful substances, thereby improving the vaporization efficiency and a fragrance reduction degree and avoiding the problems that the temperature of the heating element 101 is excessively high and the harmful substances exceed a standard. The heating element 101 is controlled to decrease from the first preset temperature to the second preset temperature within the third time period and keep working under the second preset temperature to the preset duration, to avoid the problem that the temperature of the heating element 101 generally increases due to the heat accumulation performance of the heating element 101, thereby effectively ensuring the taste consistency of the aerosol formed through vaporization. Meanwhile, a current vaporization temperature is controlled to be a safe vaporization temperature to keep safe, so that the problem of carbon depositing on a heating surface due to a relatively low vaporization temperature is avoided. Further, the safety can be effectively ensured while quick heating is implemented.

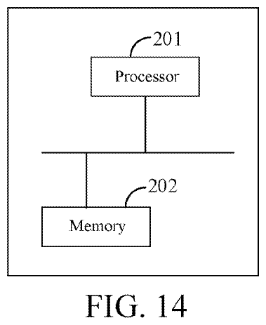

Referring to FIG. 14, FIG. 14 is a schematic structural diagram of an electronic vaporization device according to another embodiment of this application. In this embodiment, an electronic vaporization device is provided, and the electronic vaporization device includes at least one processor 201 and a memory 202 communicatively connected to the at least one processor 201. The processor 201 may be connected to the memory 202 through a bus or in another manner.

The memory 202 stores instructions executable by the at least one processor 201, and the instructions, when executed by the at least one processor 201, cause the at least one processor 201 to perform the heating control method according to any one embodiment of the foregoing.

The processor 201 may also be referred to as a central processing unit (CPU). The processor 201 may be an integrated circuit chip having a capability of processing a signal. The processor 201 may further be a general processor, a digital signal processor (DSP), an application specific integrated circuit (ASIC), a field programmable gate array (FPGA), another programmable logical device, a discrete gate, a transistor logical device, or a discrete hardware component. The general-purpose processor may be a microprocessor, or the processor may be any conventional processor or the like.

The memory 202 may be a memory chip or a trans-flash (TF) card, which may store all information in the electronic vaporization device, and inputted original data, computer programs, intermediate running results, and finally running results are all stored in the memory 202. The memory stores and reads out information according to a position specified by the controller. With the memory 202, the electronic vaporization device has a memory function and can ensure normal working. In terms of usage, the memory 202 in the electronic vaporization device may be divided into a main memory (internal memory) and an assistant memory (external memory). Further, there is a classification method of an external memory and an internal memory. The external memory is generally a magnetic medium or a compact disc which can store information for a long time. The internal memory refers to a storage part on a motherboard, which is configured to store data and program that are currently executed. However, the internal memory is merely configured to store program and data temporarily, and data will be lost if power is off.

The foregoing descriptions are merely implementations of this application, and the protection scope of this application is not limited thereto. All equivalent structure or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating control method, applicable to a heating element of an electronic vaporization device, the method comprising:
controlling the heating element to perform heating to a first preset temperature within a first time period;
controlling the heating element to keep working under the first preset temperature within a second time period; and
controlling the heating element to decrease from the first preset temperature to a second preset temperature within a third time period,
wherein the heating element is controlled to perform heating at at least two different powers within the first time period and/or the second time period.

2. The heating control method of claim 1, wherein the heating element is controlled to perform heating at at least two different powers within the first time period and/or the second time period comprises:
performing heating sequentially in descending order of the at least two different powers within the first time period; and/or
performing heating circularly and alternately at the at least two different powers within the second time period.

3. The heating control method of claim 2, wherein a minimum heating power within the first time period is not less than a maximum heating power within the second time period.

4. The heating control method of claim 1, wherein the heating element is controlled to perform heating at at least two different powers within the first time period and/or the second time period comprises:
a range of the at least two different powers is from 8 W to 11 W within the first time period; and/or
a range of the at least two different powers is from 6 W to 7.5 W within the second time period.

5. The heating control method of claim 1, wherein the heating element is controlled to perform heating at at least two different powers within the first time period and/or the second time period comprises:
heating times at the at least two different powers are the same or different within the first time period; and/or
heating times at the at least two different powers are the same or different within the second time period.

6. The heating control method of claim 1, wherein the heating element is controlled to perform heating at a constant power within the third time period.

7. The heating control method of claim 1, wherein the method stores a plurality of schemes A1 to An controlling the heating element to perform heating at the at least two different powers or a constant power within the first time period, a plurality of schemes B1 to Bn controlling the heating element to perform heating at the at least two different powers or a constant power within the second time period, and a plurality of schemes C1 to Cn controlling the heating element to perform heating within the third time period, and
wherein, before controlling the heating element to perform heating to the first preset temperature within the first time period, the method further comprises:
selecting one scheme from the plurality of schemes A1 to An, the plurality of schemes B1 to Bn, and the plurality of schemes C1 to Cn respectively to form a heating scheme.

8. The heating control method of claim 7, wherein selecting one scheme from the plurality of schemes A1 to An, the plurality of schemes B1 to Bn, and the plurality of schemes C1 to Cn respectively to form a heating scheme comprises:
obtaining parameters of the electronic vaporization device or inhale habit parameters of a user, the parameters of the electronic vaporization device comprising parameters of a vaporization substrate or parameters of a vaporizer; and
selecting, of the parameters of the electronic vaporization device or the inhale habit parameters of the user, one scheme from the plurality of schemes A1 to An, the plurality of schemes B1 to Bn, and the plurality of schemes C1 to Cn respectively to form the heating scheme.

9. The heating control method of claim 8, wherein the inhale habit parameters comprise a single inhale duration.

10. The heating control method of claim 9, wherein, after controlling the heating element to decrease from the first preset temperature to a second preset temperature within a third time period, the method further comprises:
obtaining working parameters of the electronic vaporization device under the heating scheme; and
performing self-learning of the working parameters of the electronic vaporization device under the heating scheme, to optimize selecting one scheme from the plurality of schemes A1 to An, the plurality of schemes B1 to Bn, and the plurality of schemes C1 to Cn respectively to form the heating scheme.

11. The heating control method of claim 1, wherein the first time period does not exceed 0.5 seconds, and
wherein the second time period or the third time period is from 2 seconds to 3 seconds.

12. The heating control method of claim 1, wherein a time that the heating element decreases from the first preset temperature to the second preset temperature does not exceed 0.6 seconds.

13. The heating control method of claim 1, wherein a setting range of the first preset temperature is from 220° C. to 320° C., and
wherein a setting range of the second preset temperature is from 220° C. to 280° C.

14. An electronic vaporization device, comprising:
a heating element configured to heat an aerosol-forming substrate;
a power supply component connected to the heating element and configured to supply power to the heating element; and
a controller connected between the power supply component and the heating element, the controller being configured to receive a start instruction of a user and control, according to the start instruction, the power supply component to supply power to the heating element,
wherein the controller is configured to control:
the heating element to perform heating to a first preset temperature within a first time period,
the heating element to keep working under the first preset temperature within a second time period, and
the heating element to decrease from the first preset temperature to a second preset temperature within a third time period,
wherein the heating element is configured to be controlled to perform heating at at least two different powers within the first time period and/or the second time period.

15. An electronic vaporization device, comprising:
at least one processor; and
a memory communicatively connected to the at least one processor, the memory storing instructions executable by the at least one processor, the instructions, when executed by the at least one processor, causing the at least one processor to perform the heating control method of claim 1.
